(19) United States
(12) Patent Application Publication
(10) Pub. No.: US 2002/0040364 A1
(43) Pub. Date: Apr. 4, 2002

(54) Access controlling method, its execution apparatus and record medium recording its operational program

(76) Inventors: Tsukasa Saito, Tokyo (JP); Nobuharu Miura, Tokyo (JP); Kouji Murakami, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/965,933

(22) Filed: Sep. 27, 2001

(30) Foreign Application Priority Data
Sep. 29, 2000 (JP) 2000-297937

(51) Int. Cl. G06F 17/30; G06F 17/60

(52) U.S. Cl. 707/9; 705/51; 707/104.1; 707/3

(57) ABSTRACT

An access control method for controlling an execution of an access content accepted from a user, which includes the steps of: accepting an access content representing a content of an access requested by the user; requesting an execution of the accepted access content by the sending the access content along with an attribute of the user; and executing the requested access content in a range that matches the user attribute sent together with the access content. This method allows detailed access controls tailored to individual users without increasing a burden of user management on a processor that executes the requested access content.

### BACKGROUND OF THE INVENTION

The present invention relates to an access control system for controlling the execution of a content of an access accepted from a user, and more particularly to a technology effectively applied to an access control system which controls a search for information requested by a user according to an attribute of the user.

A variety of kinds of information is available at innumerable sites on the Internet to anybody who accesses these sites. When one wishes to make information available on the Internet, he or she needs to set up a site on the Internet, prepare a file of information to be made available in the Hypertext Markup Language (HTML) and set an access right to the file such that anybody can read that information.

When a user wishes to refer to information made available to unspecified individuals, he or she may access a search site on the Internet where he searches for particular sites whose names include a specific keyword or follows links connecting to other sites to reach a target site and look up the information made available at the site. Suppose a user intends to collect information on influenza. At a search site, the user may enter a keyword “influenza” in search for sites that disclose information containing the word “influenza.”

There are sites that have their information available only to particular users by imposing limitations on access to these sites. Such access limitations are implemented, for example, by a method in which particular users are registered and given user IDs and passwords in advance and only those users who have entered the authorized user IDs and passwords are allowed an access to the information at the site.

An access control method and system is disclosed in JP-A-10-320288 which permits only those persons with a particular authority to use documents and programs and which, in services provided on the Internet, can change kinds of services that are made available and content of information that can be referenced, according to the qualification of a member accessing the site. Also disclosed in this official gazette is a storage medium storing an access control program. An outline of the access control method and system is as follows. The system holds user identification information for identifying individual users and user classification information and stores objects together with the associated user range information indicating a range of users authorized to use a particular object. When a user requests an object, the system checks the user identification information, the user classification information and the user range information to determine whether the user is authorized to use the requested object and, if the user is found to match the user range information for that object, permits the user to use the object.

The conventional technology described above has a problem that, at a site on the Internet that permits an access from any user, because the same processing is carried out no matter who is accessing, the search result may not exactly be what the user wants.

The content of information the user needs varies depending on the user's profession, i.e., according to whether the user who wants to collect information on influenza is an ordinary person with no professional medical knowledge who just want to know what influenza is or a doctor making reference to the latest kinds of influenza viruses and their vaccines. When one inquires “influenza” at the search site, all sites whose names include the keyword “influenza” are retrieved. So, the user has to look for desired information from among the collected information at these numerous sites.

To deal with this problem of failing to provide desired information, as experienced in the conventional technology, it is preferred that a detailed access control be tailored to each user. In the Internet access described above where unspecified users often access unspecified sites, however, the user management based on user IDs and passwords increases a burden of management significantly.

In the conventional technology, when the access control is to be tailored to individual users according to the user IDs and passwords, each user needs to obtain his or her user ID and password at every site in advance where object information is likely to be retrievable and to manage his user ID and password. A site administrator on the other hand must authorize different access rights to different users wishing to access that site and manage these access rights. Hence, assuming that unspecified users make access to unspecified sites, the number of user IDs and passwords to be managed increases significantly, making their management practically impossible.

### SUMMARY OF THE INVENTION

An object of the present invention is to solve the problems described above and to provide a technology that can perform a detailed access control tailored to each user without increasing a user management burden on a processor that executes a requested access content.

The present invention provides an access control system that controls an execution of an access content accepted from a user and which controls the execution of the access content requested by the user according an attribute of the user.

In the access control system of this invention, user attributes representing various attributes of users are set in a provider-side processor and information used in performing an access control according to the attribute of the user is set in an access processor that executes the access content accepted from the user.

A user-side processor accepts the access content representing the content of an access, such as information retrieval requested from the user, and sends it to the provider-side processor along with a user attribute disclosure policy indicating a policy of disclosing the user attribute.

The provider-side processor determines according to the user attribute disclosure policy the access processor that executes the processing of the accepted access content, and limits destinations to which the user attribute is to be disclosed. The provider-side processor determines according to the user attribute disclosure policy the content of the user attribute to be disclosed to the determined access processor, and limits the content of the user attribute to be disclosed. Then, provider-side processor sends the accepted access content and the limited content of the user attribute to the determined access processor and requires the access processor to execute the access content.

The access processor sets an access control level according to the user attribute supplied together with the access content, and executes the processing of the requested access content in a range that matches the access control level.

As described above, with the access control system of the present invention, because the execution of the access content requested by the user is controlled according to the user attribute, it is possible to perform a detailed access control tailored to each user without increasing a user management burden on a processor that executes the requested access content.

### BRIEF DESCRIPTION OF THE DRAWINGS

FIG. 1 is a schematic diagram showing an example configuration of an access control system according to the present invention.

FIG. 2 is a schematic diagram showing an example configuration of a provider-side processor according to the present invention.

FIG. 3 is a schematic diagram showing an example configuration of a user-side processor according to the present invention.

FIG. 4 is a schematic diagram showing an example configuration of an access processor according to the present invention.

FIG. 5 is an example of user attribute database according to the present invention.

FIG. 6 is an example of access control information database according to the present invention.

FIG. 7 is a flow chart showing a procedure for checking an access request according to the present invention.

FIG. 8 is a flow chart showing a procedure for processing an access demand according to the present invention.

FIG. 9 is a flow chart showing a procedure for executing the processing of an access according to the present invention.

FIG. 10 shows one example of user attribute disclosure policy according to the present invention.

FIG. 11 is a conceptual diagram showing an example of processing an access request according to the present invention.

FIG. 12 is a conceptual diagram showing another example of processing an access request according to the present invention.

FIG. 13 is a conceptual diagram showing still another example of processing an access request according to the present invention.

FIG. 14 is a conceptual diagram showing a further example of processing an access request according to the present invention.

### DESCRIPTION OF THE EMBODIMENTS

One embodiment of an access control system that controls the execution of a content of an access accepted from a user according to user attribute information will be described.

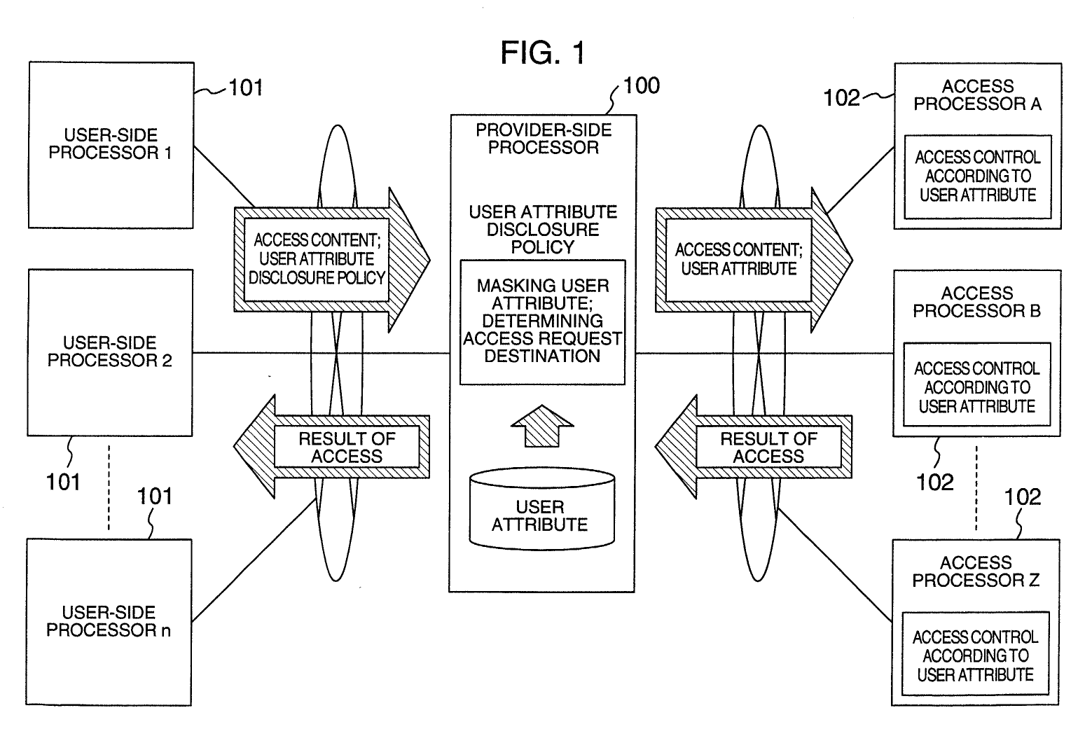

FIG. 1 shows an outline configuration of the access control system of this embodiment. The access control system of this embodiment shown in FIG. 1 has a provider-side processor 100, a user-side processor 101 and an access processor 102.

The provider-side processor 100 is an information processor on the Internet service provider side which accepts from the user-side processor 101 an access content representing a content of an access requested from a user and a user attribute disclosure policy showing a policy of disclosing an attribute of the user, and requests the access processor 102, which is determined according to the user attribute disclosure policy, to process the access content.

The user-side processor 101 is an information processor on the user side which accepts an access content and a user attribute disclosure policy from a user and requests the provider-side processor 100 to process the access content. The access processor 102 is an information processor which processes the access content, the processing of which was requested by the provider-side processor 100, within a range corresponding to the user attribute supplied together with the access content.

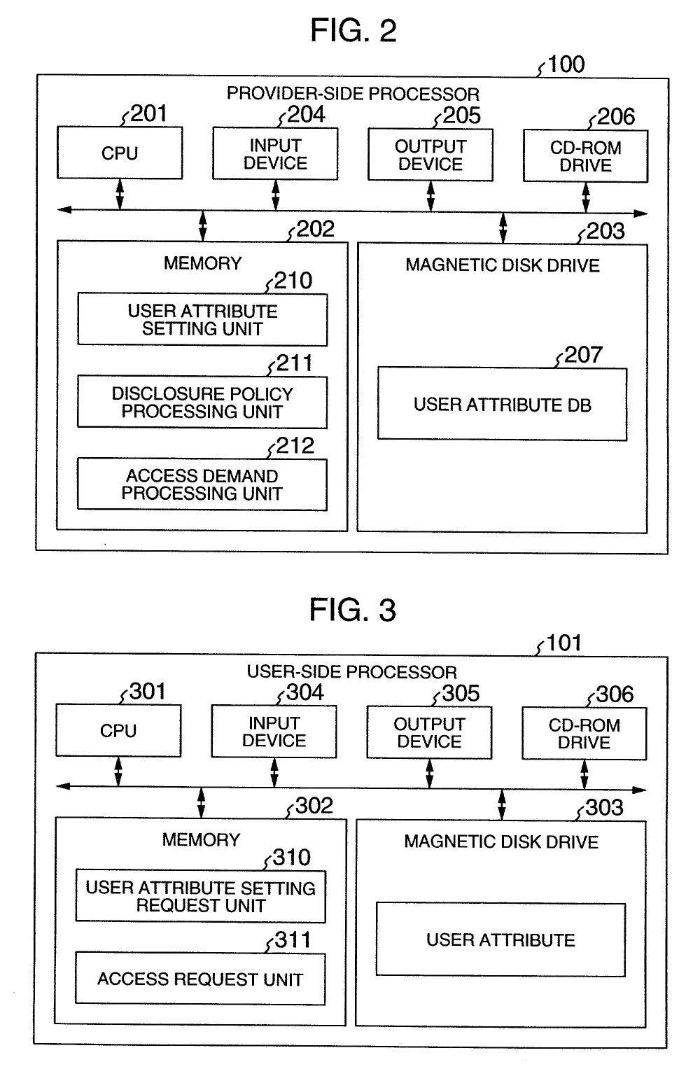

FIG. 2 shows an outline configuration of the provider-side processor 100 of this embodiment. As shown in FIG. 2, the provider-side processor 100 has a CPU 201, a memory 202, a magnetic disk drive 203, an input device 204, an output device 205, a CD-ROM drive 206, and a user attribute database (DB) 207.

The CPU 201 is a device for controlling an overall operation of the provider-side processor 100. The memory 202 is a device into which to load various programs and data in controlling the overall operation of the provider-side processor 100.

The magnetic disk drive 203 is a storage device to store the various programs and data. The input device 204 is a device to enter various inputs for requesting the access processor 102 to process the content of an access accepted from the user.

The output device 205 is a device to output various results in response to the request for processing the access content accepted from the user. The CD-ROM drive 206 is a device to read a content of a CD-ROM in which various programs are recorded. The user attribute DB 207 is a database that stores information representing attributes of users, such as name, sex, age, occupation, office and position of each user.

The provider-side processor 100 also has a user attribute setting unit 210, a disclosure policy processing unit 211 and an access demand processing unit 212.

The user attribute setting unit 210 receives the user attribute representing the attribute of a user from the user-side processor 101 and sets it in the user attribute DB 207 in the provider-side processor 100. The disclosure policy processing unit 211 receives from the user-side processor 101 the access content representing the content of an access requested by the user and the user attribute disclosure policy representing a policy of disclosing the attribute of the user and determines according to the user attribute disclosure policy the access processor 102, that processes the access content, and the content of the user attribute to be disclosed to the access processor 102. The access demand processing unit 212 requires the access processor 102, which was determined along with the user attribute content, to process the access content that was sent from the user-side processor 101.

A program that instructs the provider-side processor 100 to function as the user attribute setting unit 210, the disclosure policy processing unit 211 and the access demand processing unit 212 is recorded in a medium such as CD-ROM, transferred from the CD-ROM into a magnetic disk, and then loaded into the memory for execution. The recording medium for recording the program may be other than the CD-ROM.

FIG. 3 shows an outline configuration of the user-side processor 101 of this embodiment. As shown in FIG. 3, the user-side processor 101 has a CPU 301, a memory 302, a magnetic disk drive 303, an input device 304, an output device 305, and a CD-ROM drive 306.

The CPU 301 is a device for controlling an overall operation of the user-side processor 101. The memory 302 is a device into which to load various programs and data in controlling the overall operation of the user-side processor 101.

The magnetic disk drive 303 is a storage device to store the various programs and data. The input device 304 is a device to enter various inputs for requesting the provider-side processor 100 to process the content of an access from the user.

The output device 305 is a device to output various results in response to the request for processing the access content from the user. The CD-ROM drive 306 is a device to read a content of a CD-ROM in which various programs are recorded.

The user-side processor 101 also has a user attribute setting request unit 310 and an access request unit 311.

The user attribute setting request unit 310 makes a request to the provider-side processor 100 to set the user attribute representing the attribute of a user using the user-side processor 101. The access request unit 311 accepts the access content representing the content of an access requested by a user and the user attribute disclosure policy representing a policy of disclosing the attribute of a user, and requests the provider-side processor 100 to process the access content.

A program for instructing the user-side processor 101 to function as the user attribute setting request unit 310 and the access request unit 311 is recorded in a medium such as CD-ROM, transferred into a magnetic disk, and then loaded into memory for execution. The recording medium for recording the program may be other than the CD-ROM.

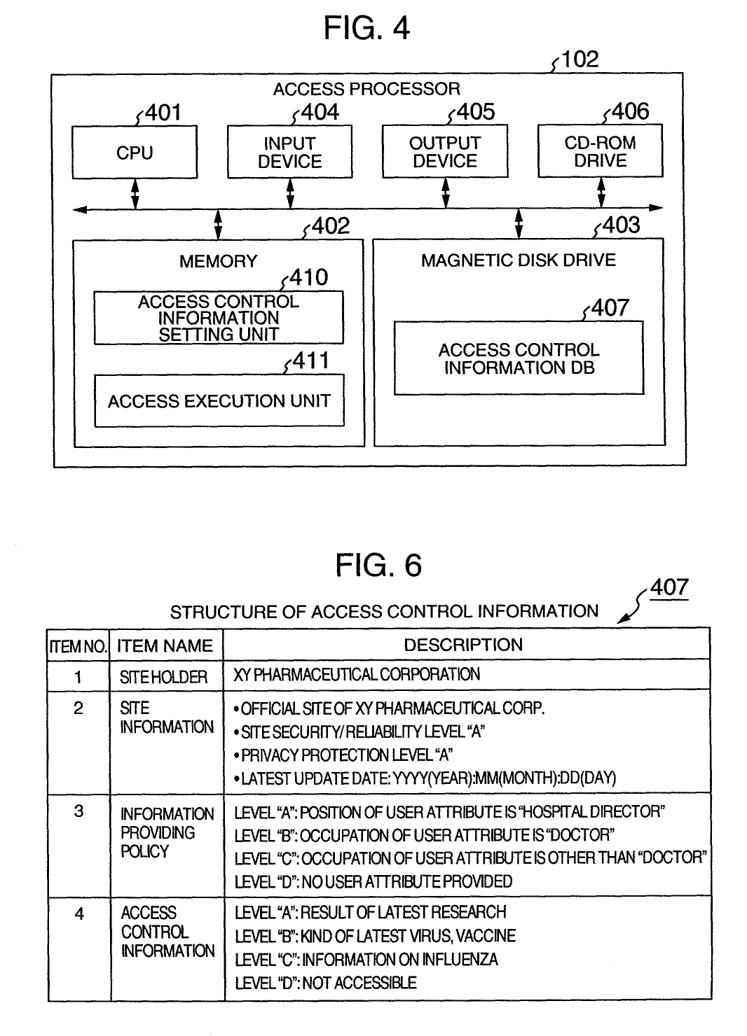

FIG. 4 shows an outline configuration of the access processor 102 of this embodiment. As shown in FIG. 4, the access processor 102 has a CPU 401, a memory 402, a magnetic disk drive 403, an input device 404, an output device 405, a CD-ROM drive 406 and an access control information DB 407.

The CPU 401 is a device for controlling an overall operation of the access processor 102. The memory 402 is a device into which to load various programs and data in controlling the overall operation of the access processor 102.

The magnetic disk drive 403 is a storage device to store the various programs and data. The input device 404 is a device to enter various inputs for executing the processing of the access content requested by the provider-side processor 100.

The output device 405 is a device to output various results obtained by the execution of the processing of the access content requested by the provider-side processor 100. The CD-ROM drive 406 is a device to read a content of a CD-ROM in which various programs are recorded. The access control information DB 407 is a database in the access processor 102 that stores attributes of a site holder, who makes the site available to the public through the access processor 102, and the content of access controls as related to user attributes.

The access processor 102 also has an access control information setting unit 410 and an access execution unit 411.

The access control information setting unit 410 sets in the access control information DB 407 information on attributes of a site holder, who opens the site to the public through the access processor 102, and on the content of access controls as related to the user attributes. The access execution unit 411 processes the access content, the processing of which was requested by the provider-side processor 100, within a range corresponding to the user attribute supplied together with the access content.

A program for instructing the access processor 102 to function as the access control information setting unit 410 and the access execution unit 411 is recorded in a medium such as CD-ROM, transferred into a magnetic disk, and then loaded into memory for execution. The recording medium for recording the program may be other than the CD-ROM.

The user attribute setting request unit 310 in the user-side processor 101 of this embodiment requests the provider-side processor 100 to set attributes of users whose use the user-side processor 101, such as name, sex, age, occupation, office and post. The user attribute setting unit 210 in the provider-side processor 100 receives the user attributes from the user-side processor 101 and set them in the user attribute DB 207 in the provider-side processor 100.

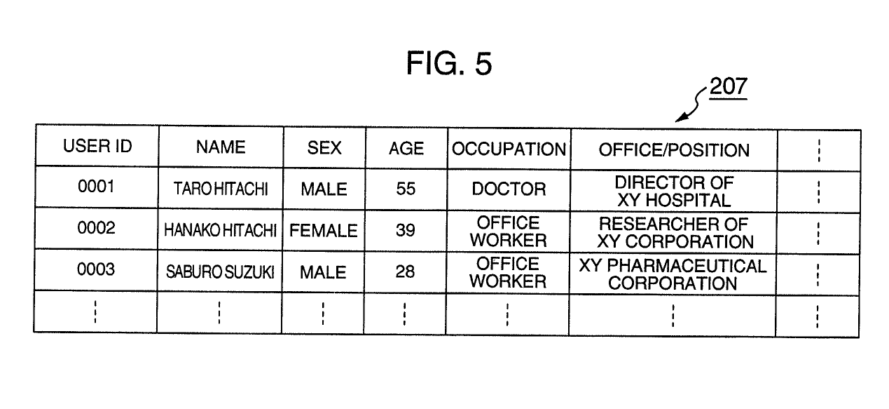

FIG. 5 illustrates an example of the user attribute DB 207 according to this embodiment. As shown in FIG. 5, the user attribute DB 207 of this embodiment stores information on name, sex, age, occupation, office and position as the user attributes.

The access control information setting unit 410 in the access processor 102 of this embodiment sets in the access control information DB 407 information on various attributes of a site owner who opens the site to the public through the access processor 102 and on the content of access controls as related to the user attributes.

FIG. 6 shows an example of the access control information DB 407 of this embodiment. As shown in FIG. 6, the access control information DB 407 of this embodiment stores a site holder's name as an attribute of a site holder, who opens the site to the public through the access processor 102, and site information. The access control information DB 407 also stores an information providing policy for setting a level representing an access range according to the user attribute when requested by the provider-side processor 100 to process the access content, and access control information indicating the content of control according to the set level. Information such as site holder's name and site information is attached with authentication information from a third-party organization to prevent possible tampering.

FIG. 6 shows an information providing policy and access control information used to search for information on influenza. The setting of the information providing policy for other access content involves setting different access control levels according to different occupations and positions. The access control information corresponding to the associated access control level is set so that the control information enables access to a higher level of information as the access control level rises.

In the access control system of this embodiment, we will describe a series of processing in which the user-side processor 101 makes a request to the provider-side processor 100 to process an access content, the provider-side processor 100 determines, according to the user attribute disclosure policy, the access processor 102 that executes the processing of the access content and the content of user attribute to be disclosed to the access processor 102, and the access processor 102 executes the processing of the access content in a range that matches the disclosed user attribute.

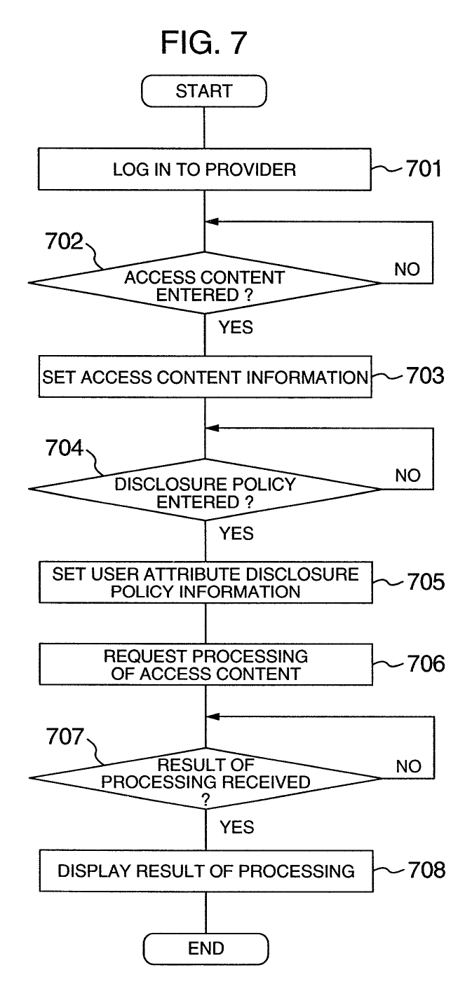

FIG. 7 is a flow chart of this embodiment showing a procedure for processing an access request. As shown in FIG. 7, the access request unit 311 of the user-side processor 101 accepts an access content representing the content of an access requested by a user and a user attribute disclosure policy representing a policy of disclosing the attribute of the user, and requests the provider-side processor 100 to process the access content.

In the access control system of this embodiment, when a user requests the access processors plugged into a network such as the Internet to process the access content such as information retrieval, the user needs to log in to the provider-side processor 100 and its network and input to the user-side processor 101 the access content and the user attribute disclosure policy that indicates to what extent the attribute of the user is to be disclosed to the access processor 102 in executing the processing.

At step 701 the access request unit 311 of the user-side processor 101 accepts a user ID and a password from the user during the long-in session and sends these information to the provider-side processor 100 to log in to that processor 100.

Step 702 checks if an access content requested by the user is entered. If so, the processing proceeds to step 703. Step 703 accepts the access content thus entered and stores it as access content information in the memory 302.

Step 704 checks whether a user attribute disclosure policy representing the policy of disclosing the attribute of the user is entered. If so, the processing moves to step 705. Step 705 accepts the user attribute disclosure policy thus entered and stores it as user attribute disclosure policy information in the memory 302.

Step 706 sends the stored access content information and user attribute disclosure policy information to the provider-side processor 100 via the network and makes a request to the provider-side processor 100 to process the access content.

Step 707 checks if a result of the processing of the access content requested is received from the provider-side processor 100. If so, the processing moves to step 708 where it displays the received result of processing on the output device 305.

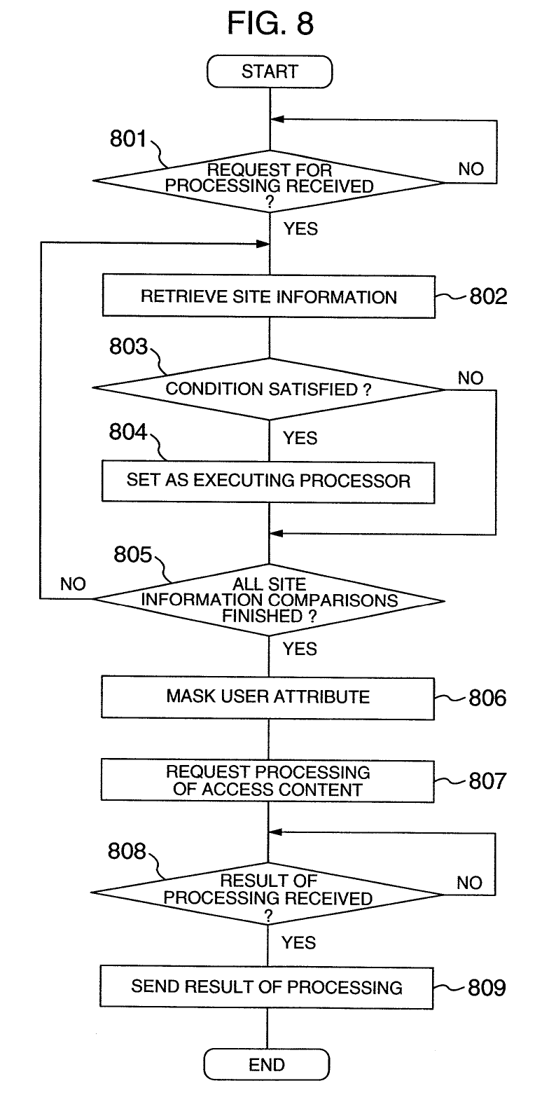

FIG. 8 is a flow chart of this embodiment showing a procedure for processing an access demand. As shown in FIG. 8, the disclosure policy processing unit 211 of the provider-side processor 100 accepts the access content representing the content of an access requested by the user and the user attribute disclosure policy indicating the policy of disclosing the attribute of the user, and determines according to the user attribute disclosure policy the access processor 102 for executing the processing of the access content and the content of user attribute to be disclosed to the access processor 102. The access demand processing unit 212 requires the access processor 102, which was determined together with the content of user attribute, to process the access content sent over from the user-side processor 101.

At step 801 the disclosure policy processing unit 211 of the provider-side processor 100 checks if a request for processing an access content is received from the user-side processor 101. If so, the processing proceeds to step 802.

Step 802 receives site information from the access processor 102 that is available for processing the access content received. Step 803 performs a validation check to see whether the access processor 102 satisfies the requirement specified by the user attribute disclosure policy by comparing the user attribute disclosure policy received from the user-side processor 101 with the site information received from the access processor 102. If the requirement of the user attribute disclosure policy is met, the processing moves to step 804 where it sets the access processor 102 that meets the conditions of the user attribute disclosure policy as a processor that executes the processing of the access content.

Step 805 checks whether the site information has been received from all access processors 102 that are available for processing the received access content. When any access processors 102 exist from which the site information is not yet received, the processing returns to step 802. When the site information is received from all the access processors 102, the processing proceeds to step 806.

Although this embodiment decides whether the user attribute disclosure policy conditions are met by receiving the site information from the access processors 102, the check on whether the user attribute disclosure policy conditions are met may be made by receiving the site information from each of the access processors 102 in advance, storing them in the provider-side processor 100 and then making comparison between the user attribute disclosure policy received from the user-side processor 101 and the site information stored in the provider-side processor 100.

Step 806 reads the user attribute corresponding to the user ID from the user attribute DB 207 according to the user attribute disclosure policy received from the user-side processor 101 and sets masked user attribute information to be disclosed to the access processor 102.

At step 807 the access demand processing unit 212 sends the access content and the masked user attribute information to the access processor 102 that was set as a processor to execute the processing of the access content transmitted from the user-side processor 101 and requires the set access processor 102 to process the access content.

Step 808 checks if a result of processing the requested access content is received from the access processor 102. If so, the processing proceeds to step 809. Step 809 sends the received result to the user-side processor 101 that requested the processing of the access content.

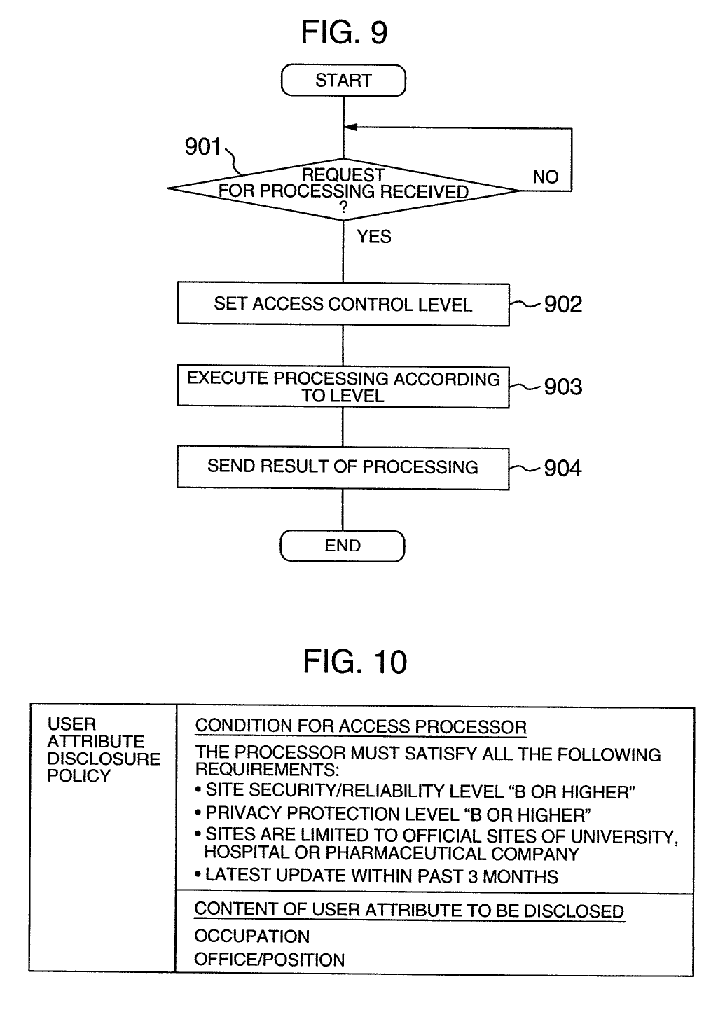

FIG. 9 is a flow chart of this embodiment showing a procedure for executing the processing of an access. As shown in FIG. 9, the access execution unit 411 of the access processor 102 executes the processing of the access content demanded by the provider-side processor 100 in a range that matches the user attribute sent over from the provider-side processor 100 together with the access content.

At step 901 the access execution unit 411 of the access processor 102 checks if a demand for processing the access content is received from the provider-side processor 100. If so, the processing proceeds to step 902.

Step 902 performs a validation check to see whether the user attribute satisfies the conditions specified by the information providing policy, by comparing the masked user attribute information received from the provider-side processor 100 with the information providing policy in the access control information DB 407. Then, the access control level used for processing the access content is set.

Step 903 references the content of the access control information in the access control information DB 407 and executes the processing of the access content in a range defined by the set access control level. Step 904 sends a result of processing the access content in step 903 to the provider-side processor 100.

In the access control system of this embodiment, we will describe a series of processing in which the user-side processor 101 requests the provider-side processor 100 to retrieve information on influenza, the provider-side processor 100 determines, according to the user attribute disclosure policy, the access processor 102 that executes the information retrieval and the content of user attribute to be disclosed to the access processor 102, and the access processor 102 executes the information retrieval in a range that matches the disclosed user attribute.

At step 701 in FIG. 7 the access request unit 311 of the user-side processor 101 sends a user ID and password to the provider-side processor 100 to log in to that processor. Step 702 enters, as the access content requested by the user, a content of search which may, for example, be a “retrieval of information on influenza as latest and detailed as possible”. This content of search is stored in the memory 302 as the search content information in step 703. At step 704 the access request unit 311 enters information, such as shown in FIG. 10, as the user attribute disclosure policy representing the policy of disclosing the attribute of the user. Step 705 stores this information in the memory 302 as the user attribute disclosure policy information.

FIG. 10 shows an example of the user attribute disclosure policy of this embodiment. As shown in FIG. 10, the user attribute disclosure policy of this embodiment is set with information representing the conditions for the information retrieval performed by the access processor 102, such as site security/reliability level of “B or higher”, privacy protection level of “B or higher”, official site of university, hospital or pharmaceutical company, and latest update within past 3 months. The content of the user attribute information to be disclosed to the access processor 102 has occupation and office/position set therein.

Step 706 sends the stored search content information and user attribute disclosure policy information to the provider-side processor 100 via the network and requests the provider-side processor 100 to retrieve the information.

At step 801 in FIG. 8 the disclosure policy processing unit 211 of the provider-side processor 100 receives the information retrieval request from the user-side processor 101 and proceeds to step 802, where it retrieves, from the access processor 102 available to perform the information retrieval, site information such as site security/reliability level of “A”, privacy protection level of “A” and latest update: YYYY (year):MM (month):DD (day) at official site of an XY pharmaceutical company, as shown in FIG. 6.

Step 803 compares the user attribute disclosure policy received from the user-side processor 101 (site security/reliability level of “B or higher”, privacy protection level of “B or higher”, official site of university, hospital or pharmaceutical company, and latest update within past 3 months) with the retrieved site information received from the access processor 102 (site security/reliability level of “A”, privacy protection level of “A” and latest update: YYYY (year):MM (month):DD (day) at official site of an XY pharmaceutical company) to perform a validation check to see whether the access processor 102 meets the condition specified by the user attribute disclosure policy. Step 804 sets the access processor 102 that satisfies the condition of the user attribute disclosure policy as a processor for executing the information retrieval.

Step 805 checks whether the site information has been received from all the access processors 102 that are available for performing the information retrieval. If so, the processing moves to step 806.

According to the user attribute disclosure policy received from the user-side processor 101, step 806 reads information corresponding to the user ID, such as occupation: “doctor” and office/position: “director of XY hospital”, from the user attribute DB 207 and then sets the masked user attribute information to be disclosed to the access processor 102.

At step 807 the access demand processing unit 212 sends the search content and the masked user attribute information to the access processor 102, which was set as a processor to execute the information retrieval, and requires the set access processor 102 to perform the information retrieval.

At step 901 the access execution unit 411 of the access processor 102 receives an information retrieval demand from the provider-side processor 100 and moves to step 902. Step 902 compares the content of the masked user attribute information received from the provider-side processor 100 (occupation “doctor” and office/position “director of XY hospital”) with the content of the information providing policy stored in the access control information DB 407 to perform a validation check to see if the user attribute meets the condition specified by the information providing policy. The access execution unit 411 then sets a level “A” as the access control level used in performing the information retrieval.

Step 903 refers to the content of the access control information in the access control information DB 407 and performs information search within a range of the set level “A”. That is, the level “A” permits access to information on the latest research result and thus the database containing the information on the latest research result is searched through. In the level “A” range, it is possible to make information lower than this level also accessible, i.e., a search is made through a database containing information on the kinds of latest viruses and their vaccines or the level “B” information and a database containing information on influenza or the level “C” information. Step 904 forwards the result of information retrieval performed at step 903 to the provider-side processor 100.

At step 808 the access demand processing unit 212 of the provider-side processor 100 receives the result of information retrieval corresponding to the user attribute, including the information on the latest research result, and at step 809 forwards the result of information retrieval to the user-side processor 101 that requested the information retrieval. At step 707 the access request unit 311 of the user-side processor 101 receives the result of information retrieval corresponding to the user attribute, including the information on the latest research result, and at step 708 displays the result of information retrieval on the output device 305.

In this embodiment because the content of access is processed according to the user attribute information as described above, it is possible to perform a detailed access control tailored to each user without increasing a burden or risk on the access processor 102 side which would otherwise be caused by the management of a large number of users.

In this embodiment, because the content of user attribute to be disclosed and the destination to which it is disclosed are limited according to the user attribute disclosure policy, the privacy of the user can be protected. Further, in this embodiment, two validation checks are made, one for determining whether the access processor 102 meets the condition specified by the user attribute disclosure policy and one for determining whether the attribute of the user meets the condition specified by the information providing policy. That is, bi-directional validation checks—a validation check based on the policy on the user side and a validation check based on the policy on the access processor 102 side—are performed, so that a more sophisticated access control can be made.

Further, in this embodiment it is possible to unify the information interfaces among the processors and to apply the system to an agent technology that automatically requests and retrieves information. This allows various access processing, including bi-directional validation checks and information request/retrieval, to be executed by agents, making it possible to completely automate a detailed control.

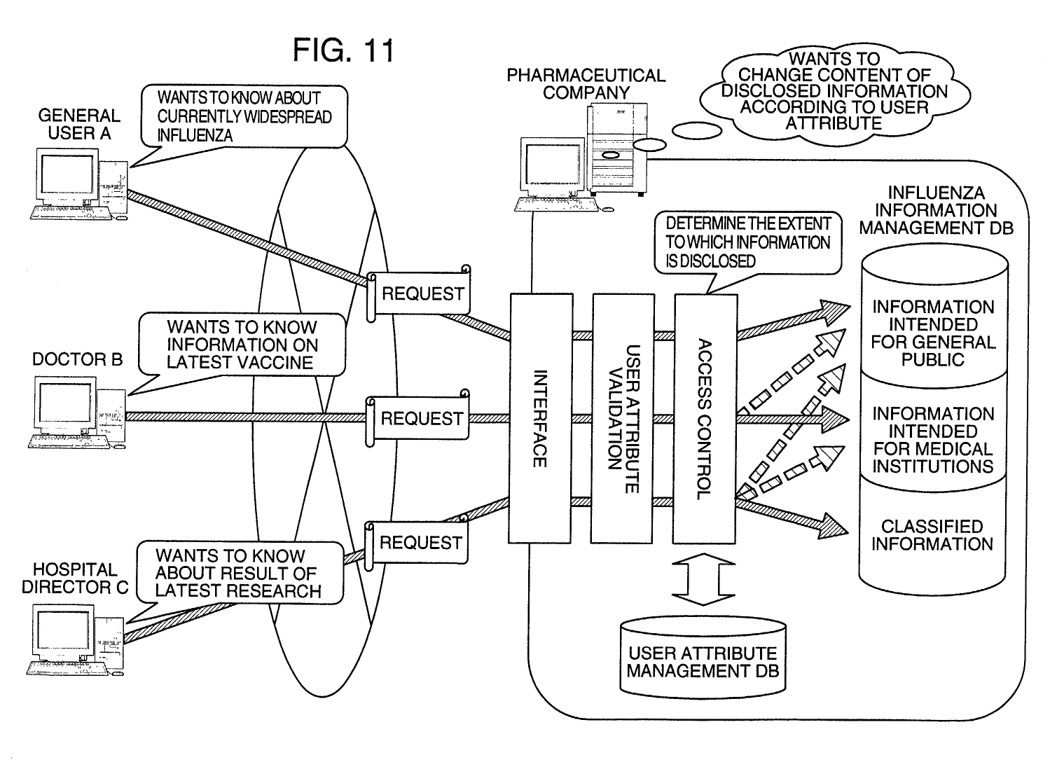

Further, by referring to FIG. 11 through FIG. 14, example forms of use of the access request processing according to the present invention will be described.

FIG. 11 illustrates an example case where access requests are made to a certain pharmaceutical company from a variety of users. As shown in the figure, it is assumed that the pharmaceutical company has accumulated very useful information on influenza viruses and wishes to make these information available to the public through the Internet. It should be noted, however, that these information includes classified information and thus not all of the accumulated information can be made open to the general public. Hence, the pharmaceutical company determines to what extent the information can be disclosed to each individual requesting the information, according to the user attribute attached to the access request.

For a request from a general user A, for example, only basic information on influenza will be provided.

For a request from a doctor B, however, more detailed information on influenza required for medical treatment and prevention will be supplied, such as information on the kinds of latest viruses and their vaccines. The information to be supplied, however, is limited to those already known to the public.

For a request from a hospital director C who is conducting a joint research with this pharmaceutical company, information including even classified one scheduled to be presented to an academic meeting will be made available.

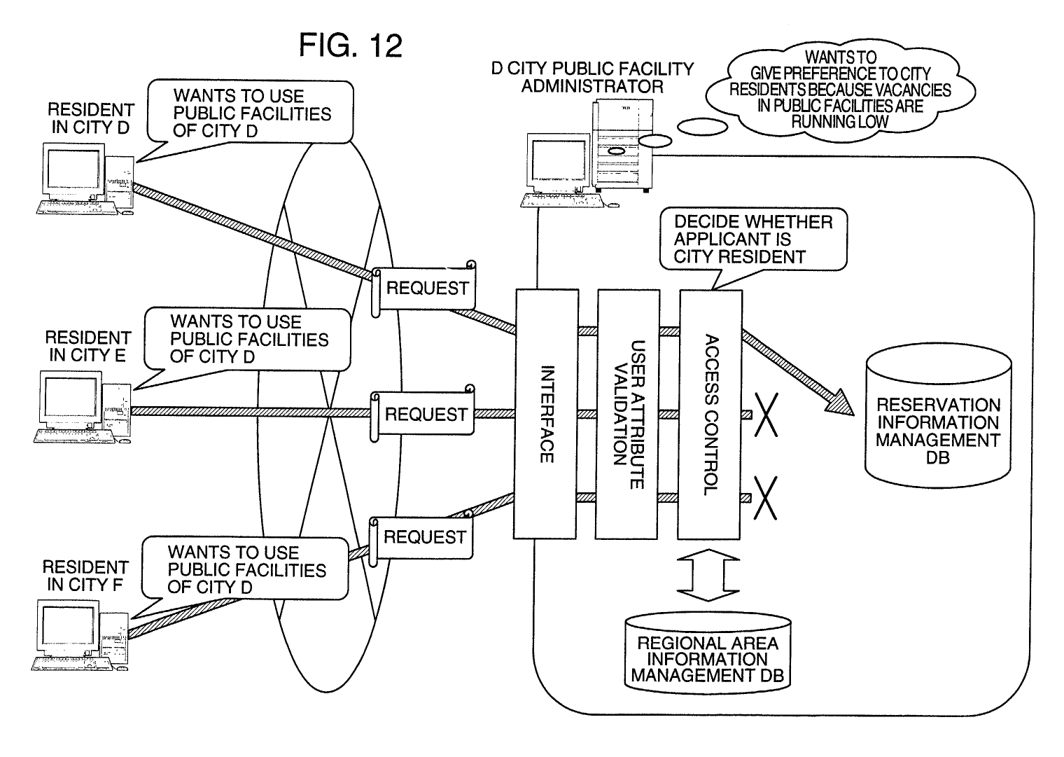

FIG. 12 illustrates an example case where requests for use of public facilities are accepted over the Internet. In the figure, in accepting reservations over the Internet for use of public facilities in a city D, let us consider a case where an administrator wishes to give a preference to residents of the city as practically as possible. This may be achieved generally by considering the name and address of a person who makes a reservation. The decision on how the priority should be given, however, is difficult to make from the reservations over the Internet. To deal with this problem, region information may be added to the user attribute for use in the decision making, enabling the above-described access control with preference.

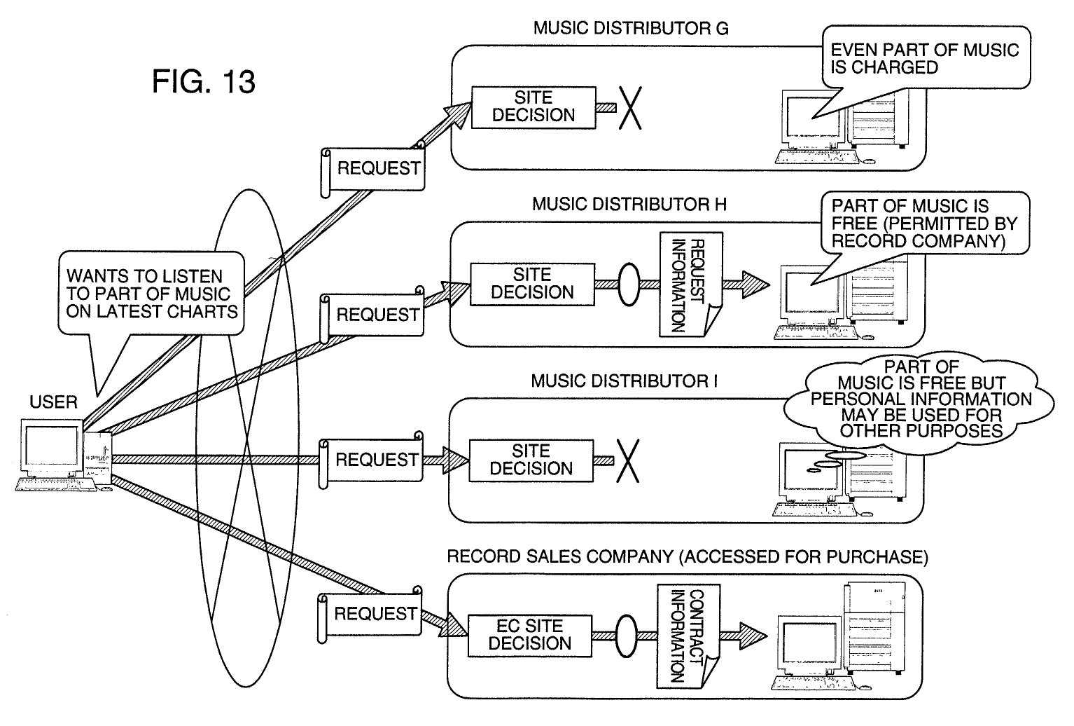

FIG. 13 illustrates a case where music is distributed over the Internet. A user wants to buy music from among top ten on the latest charts but does not know the title of the music. So he or she considers searching for a site where he “can listen to only an impressive part of the music” and then purchasing the music as a “digital content” through the Internet distribution. As shown in the figure, there are sites that may charge even for listening to only a part of music (content provider G), or sites that may provide a portion of music for free but require the user to enter his or her personal information and use them for other purposes (content provider I). With this system, the user can decide on the security from the reliability level of a site, or put some sites out of his range of access not to give his personal information to or sign a contract with these sites.

When the user finds the title of the object music and purchases it as a digital content, this system can meet a requirement that the user can purchase it from a least expensive site among those with high reliability.

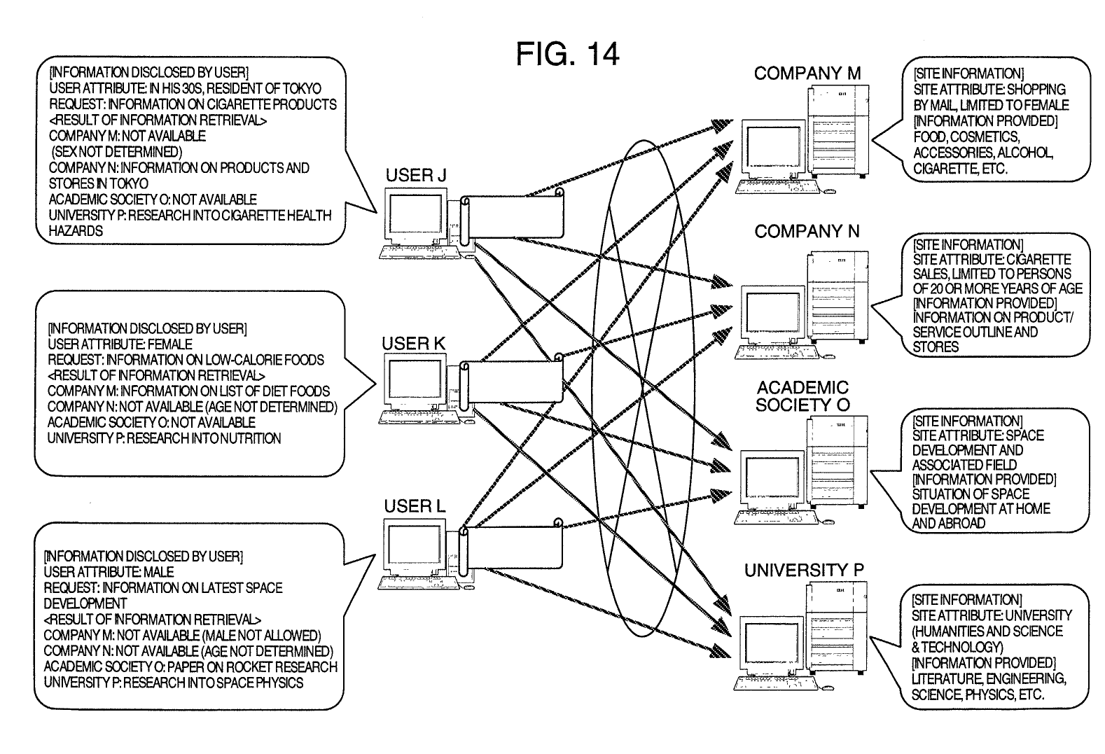

FIG. 14 illustrates a case where there are a plurality of users and a plurality of information providers. The preceding examples shown in FIG. 11 to FIG. 13 represent the cases where the users and the information providers are in a 1-to-n or n-to-1 correspondence and the users must already know the sites of the needed information. This invention can further build an information flow in an m-to-n correspondence between the users and the information providers by comprehensively taking into account the policies of the users who want to collect every associated information and of the information providers who want to make appropriate information available to each user over the boundless world of the Internet.

To realize this, the Internet service providers to which individual users belong send access requests successively to a plurality of information providers when they extract the user attributes according to the user attribute disclosure policy (the upper limit of the number of sites to be accessed is set either by the user or the provider). As a result, each user can collect from a variety of information providers every information associated with the content of a request the user makes. The information providers on the other hand can provide more appropriate information to the individual users.

More specifically, FIG. 14 shows that a user J makes a request for retrieving information on cigarette products and has a user attribute indicating that he is in his 30s and lives in Tokyo. As a result of information retrieval, as shown in the figure, the user J was able to obtain from a company N and a university P information on cigarette products and stores in Tokyo and formation on research into cigarette's health hazards. A company M has a site attribute which limits the user access only to females and no information was obtained from this company. An academic society O has a site attribute associated with space development and thus provides information on the situations of space development at home and abroad. Hence, the information requested by the user J is not available at this site.

What is claimed is:

1. An access control method for controlling an execution of an access content accepted from a user, the method comprising the steps of:
accepting an access content representing a content of an access requested by the user;
requesting an execution of the accepted access content by sending the access content along with an attribute of the user; and
executing the requested access content in a range that matches the user attribute sent together with the access content.

2. The access control method according to claim 1, wherein a content of the user attribute to be disclosed is limited according to a user attribute disclosure policy.

3. The access control method according to claim 1, wherein a destination to which the user attribute is to be disclosed is limited according to a user attribute disclosure policy.

4. The access control method according to claim 2, wherein a destination to which the user attribute is to be disclosed is limited according to a user attribute disclosure policy.

5. An access control system for controlling an execution of an access content accepted from a user, the system comprising:
an access request unit to accept an access content representing a content of an access requested by the user;
an access demand unit to request an execution of the accepted access content by sending the access content along with an attribute of the user; and
an access execution unit to execute the requested access content in a range that matches the user attribute sent together with the access content.

6. A computer-readable recording medium, which records a program for making a computer function as an access control system that controls an execution of an access content accepted from a user, the program recorded in the medium making a computer function as:
an access request unit to accept an access content representing a content of an access requested by the user;
an access demand unit to request an execution of the accepted access content by sending the access content along with an attribute of the user; and
an access execution unit to execute the requested access content in a range that matches the user attribute sent together with the access content.
